(19) United States
(12) Patent Application Publication
(10) Pub. No.: US 2014/0181067 A1
(43) Pub. Date: Jun. 26, 2014

(54) METHOD AND APPARATUS OF ORDERING SEARCH DATA, AND DATA SEARCH METHOD AND APPARATUS

(71) Applicant: Alibaba Group Holding Limited, Grand Cayman (KY)

(72) Inventor: Huaqing Song, Hangzhou (CN)

(73) Assignee: Alibaba Group Holding Limited, Grand Cayman (KY)

(21) Appl. No.: 14/133,048

(22) Filed: Dec. 18, 2013

(30) Foreign Application Priority Data
Dec. 25, 2012 (CN) 201210572391.5

(51) Int. Cl. G06F 17/30

(52) U.S. Cl. CPC G06F 17/30864
USPC 707/706; 707/758

(57) ABSTRACT

The present disclosure provides a method and an apparatus of ordering search data, and a method and an apparatus of data searching. The method of ordering search data includes: generating data of a moderate demand point, the data of the moderate demand point including a reference property value of a search target; and ordering a corresponding data set associated with the search target based on the data of the moderate demand point, the ordering including: obtaining the data set that is associated with the search target, and obtaining current property values of one or more search targets from the data set; computing distances between the current property values of one or more search targets and the reference property value; and ordering the one or more search targets of the data set based on the distances. The present embodiments can improve the search efficiency on top of satisfying individualized needs of a user, simplifying operations of the user and saving resource consumption of a client and a server.

### CROSS REFERENCE TO RELATED PATENT APPLICATION

This application claims foreign priority to Chinese Patent Application No. 201210572391.5 filed on Dec. 25, 2012, entitled “Method and Apparatus of Ordering Search Data, and Data Search Method and Apparatus”, which is hereby incorporated by reference in its entirety.

### TECHNICAL FIELD

The present disclosure relates to a technological field of network data search, and more particularly, relates to methods and apparatuses of ordering search data, data search methods and apparatuses.

### BACKGROUND

In existing technologies, network data search is normally realized using a search engine.

A search engine refers to a system provided to users for performing searches after organizing information that is automatically collected from the Internet. The information in the Internet is tremendous in volume without a specific order. All pieces of information are like small islands in an ocean with web page links acting as bridges interconnecting these islands. The search engine renders a clear information map for the users, allowing the users to perform searches at any time.

Working principles of a search engine may be roughly divided as follows:

(1) Information collection: Information collection of a search engine is basically performed automatically. The search engine uses an automatic searching robot program, which is referred to as a network “spider”, to connect from a few web pages to all links associated with other web pages in a database based on hyperlinks in the web pages. Theoretically, if a web page includes an appropriate hyperlink, the robot program may traverse a majority of web pages.

(2) Information arrangement: A process of arranging information by a search engine is referred to as “index creation”. A search engine needs not only to store information that has been collected, but also to arrange the information according to a specific rule. As such, the search engine can quickly find desired information without repeatedly searching all pieces of information stored thereby.

(3) Query receipt: A user submits a query to a search engine. The search engine receives the query and returns a search result to the user. A search engine receives queries from an enormous number of users almost simultaneously at any time, checks its own indices in accordance with a request of each user, finds out respective search results desired by the users within a very short period of time, and returns the results to the users. Currently, a search engine returns a result mainly in the form of web page links. Through these links, a user can access a web page containing his/her desired information. Generally, the search engine provides brief summaries obtained from these web pages to help a user to determine whether a web page contains his/her desired data.

In existing technologies, a search engine normally needs a user to first submit a search condition, such as inputting a keyword or setting a search range, etc., to initiate a query. A search result returned by the search engine corresponds only to web page links obtained by a network spider from a database, without taking personalized needs of the user into account.

Recently, search engines within certain websites, such as product search engines or commodity search engines in certain electronic commerce websites, provide some personalized search functionalities, and automatically recommend a search result suitable for the needs of a user based on multi-dimensional information, such as the user's behavior, a product, a sales volume, etc., without the user providing a search condition. However, in these existing schemes, the number of dimensions set up is relatively large and is not transparent. Weights that are set up for these dimensions cannot be adjusted, thus usually failing to satisfy the actual needs of a user. Under this circumstance, a user must submit a search condition to re-trigger the search engine to perform a new search operation in order to obtain his/her desired search result.

Apparently, the existing search technologies not only fail to fully satisfy personalized needs of a user and require tedious operations by the user, but also consume excessive resources of a client and a server, thus having low search efficiency.

As such, a problem urgently needed to be solved by one of ordinary skill in the art is to provide a mechanism for ordering and searching data that improve the search efficiency on the basis of fully satisfying personalized needs of a user, simplifying operations of the user and reducing resource consumption of a client and a server.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or computer-readable instructions as permitted by the context above and throughout the present disclosure.

The present disclosure provides methods of ordering search data and searching data in order to improve the search efficiency on the basis of simplifying operations of a user and reducing resource consumption of a client and a server.

Correspondingly, the present disclosure also provides apparatuses of ordering search data and searching data for realizing applications of the above methods in practice.

In order to solve the aforementioned problem, the present disclosure discloses a method of ordering search data, which includes:

generating data of a moderate demand point, the data of the moderate demand point including a reference property value of a search target; and

ordering a corresponding data set associated with the search target based on the data of the moderate demand point, the ordering including:

obtaining the data set that is associated with the search target, and obtaining current property values of one or more search targets from the data set;

computing distances between the current property values of one or more search targets and the reference property value; and

ordering the one or more search targets of the data set based on the distances.

In at least one embodiment, generating the data of the moderate demand point includes:

obtaining historical search results of the one or more search targets and extracting historical property values and historical search order weights of the one or more search targets; and

computing a centroid based on the historical property values and the historical search order weights of the one or more search targets, and setting the centroid as the reference property value of the search target.

In at least one embodiment, the centroid is computed using the following formula:

$$Y = \frac{{\sum }_{i = 1}^{k} {m}_{i} {X}_{i}}{{\sum }_{i = 1}^{k} {m}_{i}} ,$$

wherein k is the number of search targets, m is a historical search order weight of a search target, and Xᵢ is a historical property value of the search target.

In at least one embodiment, the historical search results of the one or more search targets include historical search results of the one or more search targets obtained for queries that are initialized by a plurality of users.

Computing the centroid based on the historical property values and the historical search order weights of the one or more search targets, and setting the centroid as the reference property value of the search target, includes:

1) separately computing respective centroids of s number of users using the following formula, wherein s is a positive integer greater than one:

$$Y = \frac{{\sum }_{i = 1}^{k} {m}_{i} {X}_{i}}{{\sum }_{i = 1}^{k} {m}_{i}} ,$$

wherein k is the number of search targets, m is a historical search order weight of a search target, Xᵢ is a historical property value of the search target;

2) obtaining the respective centroids of the s number of users as {Y₁, Y₂, . . . , Y₅};

3) obtaining a centroid as the reference property value of the search target from the respective centroids of the s number of users using the following formula:

$${Y}_{new} = \frac{{\sum }_{i = 1}^{s} {Y}_{i}}{s} ,$$

wherein Yᵢ is from Y₁ to Y₅.

In at least one embodiment, the plurality of users are neighbor users, the neighbor users including a user set of users having a degree of similarity greater than a first threshold value.

In at least one embodiment, the reference property value, the historical property values, and the current property values of the search target are represented as a n-dimensional vector of X={x₁, x₂, . . . , xₙ}, wherein n is a positive integer.

In at least one embodiment, ordering the corresponding data set associated with the search target based on the data of the moderate demand point further includes:

deleting a specific search target from the data set of the search target, the specific search target being a search target having a distance between the reference property value and the current property value thereof greater than a second threshold value.

The present disclosure also provides a method of searching data, which includes:

generating data of a moderate demand point, the data of the moderate demand point including a reference property value of a search target;

obtaining behavior information of a user who initiates a search;

fetching data of a matched moderate demand point based on the behavior information of the user who initiates the search; and

returning, to the user who initiates the search, a data set of a corresponding search target that is obtained based on the data of the matched moderate demand point;

wherein one or more search targets included in the data set of the search target include current property values, and the one or more search targets are ordered according to distances between the current property values and the reference property value of the search target.

In at least one embodiment, generating the data of the moderate demand point includes:

obtaining historical search results of the one or more search targets and extracting historical property values and historical search ordering weights of the one or more search targets; and

calculating a centroid according to the historical property values and the historical search ordering weights of the one or more search targets and setting the centroid as the reference property value of the search target.

In at least one embodiment, the centroid is computed using the following formula:

$$Y = \frac{{\sum }_{i = 1}^{k} {m}_{i} {X}_{i}}{{\sum }_{i = 1}^{k} {m}_{i}} ,$$

wherein k is the number of search targets, m is a historical search order weight of a search target, and Xᵢ is a historical property value of the search target.

In at least one embodiment, the historical search results of the one or more targets include historical search results of the one or more search targets obtained for queries that are initialized by a plurality of users.

Computing the centroid based on the historical property values and the historical search order weights of the one or more search targets, and setting the centroid as the reference property value of the search target, includes:

1) separately computing respective centroids of s number of users using the following formula, wherein s is a positive integer greater than one:

$$Y = \frac{{\sum }_{i = 1}^{k} {m}_{i} {X}_{i}}{{\sum }_{i = 1}^{k} {m}_{i}} ,$$

wherein k is the number of search targets, m is a historical search order weight of a search target, Xᵢ is a historical property value of the search target;

2) obtaining the respective centroids of the s number of users as {Y₁, Y₂, . . . , Y₅};

3) obtaining a centroid as the reference property value of the search target from the respective centroids of the s number of users using the following formula:

$${Y}_{new} = \frac{{\sum }_{i = 1}^{s} {Y}_{i}}{s} ,$$

wherein Yᵢ is from Y₁ to Y₅.

In at least one embodiment, the plurality of users are neighbor users, the neighbor users including a set of users having a degree of similarity for user behavior greater than a first threshold value.

In at least one embodiment, the reference property value, the historical property values, and the current property values of the search target are represented as a n-dimensional vector of X={x₁, x₂, . . . , xₙ}, wherein n is a positive integer.

In at least one embodiment, fetching the data of the matched moderate demand point based on the behavior information of the user who initiates the search includes:

calculating a degree of similarity between the behavior information of the user who initiates the search and behavior of a neighbor user set;

determining that the behavior information of the user who initiates the search belongs to the neighbor user set when the degree of similarity is greater than a first threshold value; and

fetching a reference property value of a search target corresponding to the neighbor user set to which the user who initiates the search belongs, and setting the reference property value of the search target as the data of the moderate demand point corresponding to the user who initiates the search.

In at least one embodiment, returning, to the user who initiates the search, the data set of the corresponding search target that is obtained based on the data of the matched moderate demand point includes:

obtaining current search results of the one or more search targets, and fetching current property values of the one or more search targets;

separately computing respective distances between the current property values of the one or more search targets and the reference property value;

ordering the one or more search targets according to the respective distances; and

returning the ordered data set of the search target set to the user.

In at least one embodiment, returning, to the user who initiates the search, the data set of the corresponding search target that is obtained based on the data of the matched moderate demand point further includes:

deleting a specific search target from the data set of the search target, the specific search target being a search target having a distance between the reference property value and the current property value thereof greater than a second threshold value.

The present disclosure also provides an apparatus of ordering search data, which includes:

a moderate demand point generation module used for generating data of a moderate demand point, the data of the moderate demand point including a reference property value of a search target; and

a moderate demand point ordering module used for ordering a corresponding data set associated with the search target based on the data of the moderate demand point, the moderate demand point ordering module including:

a search result acquisition sub-module used for obtaining the data set that is associated with the search target, and obtaining current property values of one or more search targets from the data set;

a distance computation sub-module used for computing distances between the current property values of one or more search targets and the reference property value; and

an ordering sub-module used for ordering the one or more search targets of the data set based on the distances.

In at least one embodiment, the moderate demand point generation module includes:

a historical search result analysis sub-module used for obtaining historical search results of the one or more search targets and extracting historical property values and historical search order weights of the one or more search targets; and

a moderate demand point computation sub-module used for computing a centroid based on the historical property values and the historical search order weights of the one or more search targets, and setting the centroid as the reference property value of the search target.

In at least one embodiment, the centroid is computed using the following formula:

$$Y = \frac{{\sum }_{i = 1}^{k} {m}_{i} {X}_{i}}{{\sum }_{i = 1}^{k} {m}_{i}} ,$$

wherein k is the number of search targets, m is a historical search order weight of a search target, and Xᵢ is a historical property value of the search target.

In at least one embodiment, the historical search results of the one or more targets include historical search results of the one or more search targets obtained for queries that are initialized by a plurality of users.

The moderate demand point computation sub-module further includes:

a single-user centroid computation unit used for separately computing respective centroids of s number of users using the following formula, wherein s is a positive integer greater than one:

$$Y = \frac{{\sum }_{i = 1}^{k} {m}_{i} {X}_{i}}{{\sum }_{i = 1}^{k} {m}_{i}} ,$$

wherein k is the number of search targets, m is a historical search order weight of a search target, Xᵢ is a historical property value of the search target;

a centroid organization unit used for obtaining the respective centroids of the s number of users as {Y₁, Y₂, . . . , Y₅};

a multiple-user centroid computation unit used for obtaining a centroid as the reference property value of the search target from the respective centroids of the s number of users using the following formula:

$${Y}_{new} = \frac{{\sum }_{i = 1}^{s} {Y}_{i}}{s} ,$$

wherein Yᵢ is from Y₁ to Y₅.

In at least one embodiment, the plurality of users correspond to neighbor users. The neighbor users may include a set of users having a degree of similarity for user behavior greater than a first threshold value.

In at least one embodiment, the moderate demand point ordering module further includes:

a filtering sub-module used for deleting a specific search target from the data set of the search target, the specific search target being a search target having a distance between the reference property value and the current property value thereof greater than a second threshold value.

The present disclosure also provides an apparatus of data searching, which includes:

a moderate demand point generation module used for generating data of a moderate demand point, the data of the moderate demand point including a reference property value of a search target;

a behavior information acquisition module used for obtaining behavior information of a user who initiates a search;

a matched point fetching module used for fetching data of a matched moderate demand point based on the behavior information of the user who initiates the search; and

a search result returning module used for returning, to the user who initiates the search, a data set of a corresponding search target that is obtained based on the data of the matched moderate demand point, wherein one or more search targets included in the data set of the search target include current property values, and the one or more search targets are ordered according to distances between the current property values and the reference property value of the search target.

In at least one embodiment, the moderate demand point generation module includes:

a historical search result analysis sub-module used for obtaining historical search results of the one or more search targets and extracting historical property values and historical search ordering weights of the one or more search targets; and

a moderate demand point computation sub-module used for calculating a centroid according to the historical property values and the historical search ordering weights of the one or more search targets and setting the centroid as the reference property value of the search target.

In at least one embodiment, the centroid is computed using the following formula:

$$Y = \frac{{\sum }_{i = 1}^{k} {m}_{i} {X}_{i}}{{\sum }_{i = 1}^{k} {m}_{i}} ,$$

wherein k is the number of search targets, m is a historical search order weight of a search target, and Xᵢ is a historical property value of the search target.

In at least one embodiment, the historical search results of the one or more targets include historical search results of the one or more search targets obtained for queries that are initialized by a plurality of users.

The moderate demand point computation sub-module further includes:

a single-user centroid computation unit used for separately computing respective centroids of s number of users using the following formula, wherein s is a positive integer greater than one:

$$Y = \frac{{\sum }_{i = 1}^{k} {m}_{i} {X}_{i}}{{\sum }_{i = 1}^{k} {m}_{i}} ,$$

wherein k is the number of search targets, m is a historical search order weight of a search target, Xᵢ is a historical property value of the search target;

a centroid organization unit used for obtaining the respective centroids of the s number of users as {Y₁, Y₂, . . . , Y₅};

a multiple-user centroid computation unit used for obtaining a centroid as the reference property value of the search target from the respective centroids of the s number of users using the following formula:

$${Y}_{new} = \frac{{\sum }_{i = 1}^{s} {Y}_{i}}{s} ,$$

wherein Yᵢ is from Y₁ to Y₅.

In at least one embodiment, the plurality of users are neighbor users, the neighbor users including a set of users having a degree of similarity for user behavior greater than a first threshold value.

In at least one embodiment, the matched demand point fetching module includes:

a behavior similarity degree computation sub-module used for calculating a degree of similarity between the behavior information of the user who initiates the search and behavior of a neighbor user set;

a determination sub-module used for determining that the behavior information of the user who initiates the search belongs to the neighbor user set when the degree of similarity is greater than a first threshold value; and

a matched point fetching sub-module used for fetching a reference property value of a search target corresponding to the neighbor user set to which the user who initiates the search belongs, and setting the reference property value of the search target as the data of the moderate demand point corresponding to the user who initiates the search.

In at least one embodiment, the search result returning module includes:

a search result acquisition sub-module used for obtaining current search results of the one or more search targets, and fetching current property values of the one or more search targets;

a distance computation sub-module used for separately computing respective distances between the current property values of the one or more search targets and the reference property value;

an ordering sub-module used for ordering the one or more search targets according to the respective distances; and

a feedback sub-module used for returning the ordered data set of the search target set to the user.

In at least one embodiment, the search result returning module further includes:

a filtering sub-module used for deleting a specific search target from the data set of the search target, the specific search target being a search target having a distance between the reference property value and the current property value thereof greater than a second threshold value.

As compared with the existing technologies, the present disclosure possesses the following advantages:

By setting up a moderate demand point, the disclosed method and apparatus creates a new ordering method using the moderate demand point and may continuously improve this moderate demand point to satisfy the changing demands of a user. Using the present embodiments, a user can obtain search result data that meets his/her individualized needs without requiring to submit a search condition, thus greatly simplifying operations of the user. Furthermore, each website server does not need to repeatedly process requests of a client, thereby saving resource consumption of the client and the server and effectively improving the search efficiency.

In some embodiments, data of a moderate demand point may be utilized as a query condition for submitting to a corresponding search engine, and the search engine obtains a corresponding search result (i.e., a data set of a search target) based on its own search mechanism, i.e., initiating an online search based on the data of the moderate demand point. By using this implementation, a server only stored the data of the moderate demand point, thus effectively saving resources of the server.

Additionally or alternatively, the data set of the search target corresponding to the data of the moderate demand point may be stored in the server, and a relationship between the data set of the search target and the data of the moderate demand point may be recorded. This embodiment is suitable for a search engine in a relatively small scaled website. In this situation, as the number of accesses to the website is small and the amount of user behavior information in the website is relatively small, the data of the moderate demand point can be updated regularly, rather than being updated in real time. Each time when the data of the moderate demand point is updated, the data set of the search target corresponding to the data of the moderate demand point may be stored. When a user initiates a search, a data set of a corresponding search target can be returned after being directly extracted from the server based on data of a matched moderate demand point. The present embodiment can reduce resources exchanged during communications between a client and a server and can also allow the user to obtain feedback at a faster rate.

### BRIEF DESCRIPTION OF THE DRAWINGS

FIG. 1 is a flowchart illustrating a method of ordering search data according to embodiments of the present disclosure.

FIG. 2 is a schematic diagram illustrating an example of placing product data and data of moderate demand point into a two-dimensional space of price-sales volume.

FIG. 3 is a flowchart illustrating a method of data searching according to the embodiments of the present disclosure.

FIG. 4 is a structural diagram illustrating an apparatus of ordering search data according to the embodiments of the present disclosure.

FIG. 5 is a structural diagram illustrating an apparatus of data searching according to the embodiments of the present disclosure.

FIG. 6 is a structural diagram illustrating the example apparatus as described in FIGS. 5 and 6.

### DETAILED DESCRIPTION

In order to better understand the goals, characteristics and advantages of the present disclosure, the present disclosure will be described in further detail with reference to accompanying figures and specific implementations.

One of the main concepts of the present disclosure is to adopt the Doctrine of Golden Mean of the Chinese people, seeking not the best and not the worst. For example, when shopping for products in an electronic commerce website, a purchaser does not seek for the cheapest price or the best quality, but a moderate one with respect to product qualities and prices. The present disclosure satisfies this popular mentality through technical measures. By collecting search behavior information of neighbor users with respect to search targets, the disclosed method and apparatus compute a moderate demand point for this type of users, establish a new ordering manner based on the moderate demand point, and allow continuous modification of this moderate demand point to satisfy changing needs of the users.

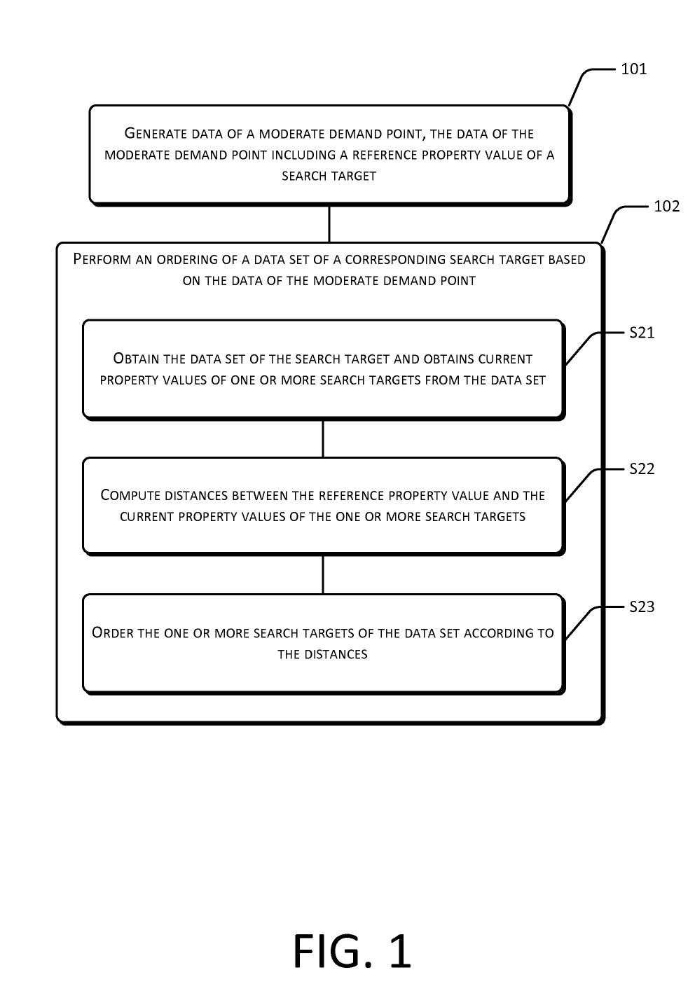

FIG. 1 shows a flowchart illustrating a method of ordering search data according to the embodiments of the present disclosure, which includes the following blocks:

Block 101 generates data of a moderate demand point. The data of the moderate demand point may include a reference property value of a search target.

The term of “moderate” comes from a proposition of Confucianism, referring to adopting a manner of harmony and compromise without going to extremes in dealing with people. In the embodiments of the present disclosure, a moderate demand point refers to a demand point of a user who is under the influence of the concept of moderation. It should be noted that a user as referred to in the embodiments of the present disclosure may correspond to a single user, a plurality of users, a user group, or all network users. Generally, a demand point of a user who is under the influence of the concept of moderation corresponds to a demand point of a majority of users who are under the influence of the concept of moderation. For example, for a search target such as a certain product, a demand point for a majority of users under the influence of the concept of moderation usually is the one that has the largest sales volume and the lowest price or the one that has the highest rate of favorable comments and the lowest price (i.e., the one having the most optimal performance/price ratio).

Data of a moderate demand point may be understood as a property value of a search target corresponding to a demand point of a user under the influence of the concept of moderation, i.e., a reference property value of a search target described in the embodiments of the present disclosure. The search target may be determined according to a suitable search engine. For example, when an Internet search engine is used in the embodiments of the present disclosure, the search target may be any type of network resource such as a picture, a video, a web page, etc. When an internal engine of a certain electronic commerce website is used in the embodiments of the present disclosure, the search target may be a product, a commodity, a service, etc. From a user perspective, the search target may also be understood as a target object, target information, target data, etc., that a user desire to find.

Using a search for a certain commodity in an electronic commerce platform as an example, the commodity can be understood as a “search target” referred in the embodiments of the present disclosure. There may be hundreds or thousands of pieces of information for that commodity (i.e., a data set of the search target) in the electronic commerce platform. A commodity in the electronic commerce platform generally possesses multiple properties, such as a price, a sales volume, a rate of favorable comments, etc. It should be noted that properties corresponding to property values (including a reference property value, a current property value, and a historical property value) may correspond to all properties of the search target, or may additionally or alternatively be either part of the properties or specific properties of the search target that a user is interested in. For example, given a commodity as a search target, related computation is performed only for property values of two properties: price and sale volumes, when a user needs only these two properties, the price and the sales volume. Furthermore, the reference property value, the current property value, and the historical property value possess consistency. For example, if a reference property value of a certain commodity (i.e., a search target) is property values of two properties: price and sales volume, current property values thereof will be current property values of these two properties: the price and the sales volume, but not current property values of any other properties such as a rate of favorable comments, a publishing time, etc., and associated historical property values will be historical property values of the price and the sales volume, but not historical property values of any other properties such as the rate of favorable comments, the publishing time, etc.

Generally, under the influence of the concept of moderation, a user usually wants to find out about a product having an optimal performance/price ratio. Examples include the one having the highest sales volume and the lowest price, or the one with the highest rate of favorable comments and the lowest price. Reference property values for a corresponding search target that satisfies such needs of the user may be with a value of 0.2 for the price and a value of 0.8 for the sale volumes, or a value of 0.9 for the rate of favorable comments and a value of 0.2 for the price. The above reference property values are merely used as examples for enhancing intuitive understanding of one of ordinary skill in the art, and in practice, may not necessarily be decimal values but may be arrays, percentages, etc. Moreover, the reference property values of the search target may be generated using not only direct value assignment method, but also multiple types of computation methods. The present disclosure has no limitation thereon. As a specific example used in the embodiments of the present disclosure, the reference property value of the search target may be represented as a n-dimensional vector of X={x₁, x₂, . . . , xₙ}, wherein n is a positive integer.

In some embodiments, the reference property value may be computed from historical search information of the search target that is obtained from one or more systems, i.e., the source data for calculating the reference property value may be obtained from a same platform, such as obtained all from an electronic commerce, or obtained from multiple different platforms, e.g., obtained respectively from a commodity system platform, a sales system platform and an operating system platform. The present disclosure has no limitation thereon.

The present disclosure does not have limitation on numerical expression forms and computation methods adopted for the reference property value. As an example, block 101 may include the following sub-blocks (not shown):

Sub-block S11 obtains historical search results of one or more search targets, and fetches historical property values and historical search ordering weights of the one or more search targets.

Sub-block S12 computes a centroid based on the historical property values and the historical search ordering weights of the one or more search targets, and sets the centroid as the reference property value of the search target.

In one embodiment, the historical search results may include a search result that has been obtained by a user in a prior search for the search target. For example, if a current search target is “iPhone”, a historical search result may include a search result that has been obtained by a user who previously submits a search for “iPhone”. Furthermore, the historical search result may also include a search result including the search target during a search that is initiated by the user for a different search target. For example, the current search target is “iPhone”. The user has previously submitted a search for “cell phone”, and a search result obtained therefor includes multiple search results associated with “iPhone”. The historical search result in the embodiments of the present disclosure may also include this situation. In one embodiment, the historical search result may be obtained from a log or a history database.

A historical property value of the search target is relative to a current property value of the search target, i.e., a historical record of the property of the search target, and may be represented as a n-dimensional vector of X={x₁, x₂, . . . , xₙ}, wherein n is a positive integer. In one embodiment, the property value of the search target may be a value after normalization, e.g., 0<x<1. Use “iPhone” as an example of a search target. iPhone is assumed to have two property values: price and sales volume, i.e., X={x₁,x₂}, and the sales volume for iPhone in a previous result is ten. The sales volume of iPhone for a seller A (a first search target) is one, and the sales volume of iPhone for a seller B (a second search target) is nine. After normalization based on a total sales volume, a property value for the sales volume of the first search target is 1/(1+9)=0.1 (the property value for the sales volume in this example corresponds to a ratio of total sales volume contributed by the first search target). Similarly, the property value for the sales volume of the second search target is 0.9.

The above method of computing a property value of a search target is only an example. It is plausible for one of ordinary skill in the art to compute the property value of the search target using any computation method based on actual needs. The present disclosure has no limitation thereon.

In one embodiment, the historical search ordering weight may be a weighting parameter used in a search engine (including an Internet search engine or a search engine within a site) for ordering matched search records. For example, an electronic commerce platform may employ a quality score of a commodity (details of which may be referenced to methods of scoring based on multiple factors, and the present disclosure has no limitation thereon) as a search ordering weight. An Internet search engine may use PageRank (a web page rank launched by Google and commonly referred to as a PR value) as a search ordering weight. The search ordering weight may also be a score value obtained by human intervention. The present disclosure has no limitation thereon.

In one embodiment, a property value and a search ordering weight of a search target may be calculated and stored in a specific database when a search result is generated in order to further enhance the efficiency of generating a reference property value of the search target.

As an example used in the embodiments of the present disclosure, a centroid may be calculated using the following formula:

$$Y = \frac{{\sum }_{i = 1}^{k} {m}_{i} {X}_{i}}{{\sum }_{i = 1}^{k} {m}_{i}} ,$$

wherein k is the number of search targets, m is a historical search order weight of a search target, and Xᵢ is a historical property value of the search target.

In some embodiments, the historical search results of the one or more search targets include historical search results of one or more search targets obtained for queries that are initialized by a plurality of users and that are targeted for a same search target or a different search target. In this case, the sub-block S12 may further include the following sub-steps:

1) separately computing respective centroids of s number of users using the following formula, wherein s is a positive integer greater than one:

$$Y = \frac{{\sum }_{i = 1}^{k} {m}_{i} {X}_{i}}{{\sum }_{i = 1}^{k} {m}_{i}} ,$$

wherein k is the number of search targets, m is a historical search order weight of a search target, Xᵢ is a historical property value of the search target;

2) obtaining the respective centroids of the s number of users as {Y₁, Y₂, . . . , Y₅};

3) obtaining a centroid as the reference property value of the search target from the respective centroids of the s number of users using the following formula:

$${Y}_{new} = \frac{{\sum }_{i = 1}^{s} {Y}_{i}}{s} ,$$

wherein Yᵢ is from Y₁ to Y₅.

It should be noted that the above formula is a simplified version of a centroid formula, which represents a situation when all search ordering weights of the search target are one. In one embodiment, it is plausible for one of ordinary skill in the art to use any formulas for calculating a centroid. The present disclosure has no limitation thereon.

In one embodiment, the data of the moderate demand point may be updated according to new search results of the one or more search targets in real time or on a regular basis. Using a search ordering of commodity data in an electronic commerce platform as an example, initially when search results of a plurality of users that include a search target have not been collected, a centroid of commodity data that is distributed in a multi-dimensional space may be computed using a single search result of a user that includes the search target, i.e., a reference property value of the search target. For example, a user initiates a MP3 commodity search (e.g., searching for MP3), and a commodity search engine returns a MP3 commodity data set. If the number of MP3 commodities is k, and one or more MP3 commodities have different search ordering weights (i.e., commodity quality scores, manifested in a web page as different ordering positions: one with a better quality is located in the front position and one with a poorer quality is located at the back position), a representation using a mathematical formula may be M={m₁, m₂, . . . , mₖ}, wherein k is the number of commodities, the value of m comes from a search system. If no search system exists, m may be set as one, indicating that quality scores for all commodities are the same, and the centroid may be calculated using the following formula:

$$Y = \frac{{\sum }_{i = 1}^{k} {m}_{i} {X}_{i}}{{\sum }_{i = 1}^{k} {m}_{i}} .$$

If s number of users has searched for MP3, each search result including the MP3 commodity has a corresponding different reference property value (i.e., the centroid as calculated in the above formula). For example, compared with reference property values of a user B, a user A has a lower price and a higher sales volume. In this case, reference property values obtained for s number of users may be represented as {Y′₁, Y′₂, . . . , Y′ₛ}.

A centroid is further obtained from centroids of the s number of users by applying the following formula and is set as the reference property value of the search target, being taken as the data of moderate demand point:

$${Y}_{new} = \frac{{\sum }_{i = 1}^{s} {Y}_{i}}{s} ,$$

wherein Yᵢ is from Y₁ to Y₅.

When additional search results of new s+1^{th} user that include the search target are obtained, updated data of the moderate demand point may be computed and obtained by applying the above formula.

In order to improve user bias of data of a moderate demand point, the plurality of users may be neighbor users. Specifically, a neighbor user, which is a concept proposed in a collaborative filtering algorithm, is referred to as a user having a same or similar preference with a target user. The neighbor users correspond to a set of users who have same or similar preference(s). A conventional neighbor user algorithm is to find a nearest neighbor set of a target user based on a rating matrix of users-items. It is plausible for one of ordinary skill in the art to employ any existing method, such as a collaborative filtering method based on matrix dimensionality reduction, a collaborative filtering method based on neural network, etc. The present disclosure has no limitation thereon. In an example of a specific implementation of the embodiments of the present disclosure, the neighbor users may be a user set having a degree of similarity of user behavior greater than a first threshold value.

The above method of generating data of a moderate demand point is merely an example. For example, a method of calculating an average value is used for a reference value of a one-dimensional search target. It is plausible for one of ordinary skill in the art to employ any method of generating data of a moderate demand point. The present disclosure has no limitation thereon.

In one embodiment, the data of the moderate demand point can be generated in a server, or may be completed offline, such as generated and stored by a search server and further updated in real time or periodically. Alternatively, after generating the data of the moderate demand point, the server may send it to a client end for storage. Alternatively, after regularly updating the data of the moderate demand point, the server may send the updated data to the client for storage. The client completes a subsequent ordering operation, thereby saving resources of the server and improving the speed of responding to a user request.

Block 102 performs an ordering of a data set of a corresponding search target based on the data of the moderate demand point.

In the embodiments of the present disclosure, the ordering may be an ordering from the nearest to the farthest that is generated using the data of the moderate demand point as the center. Specifically, block 102 may include the following sub-blocks:

Sub-block S21 obtains the data set of the search target and obtains current property values of one or more search targets from the data set.

The data set of the search target includes a data set formed by one or more search targets, e.g., commodity data associated with a plurality of sellers of iPhone that is obtained in a user search for “iPhone”.

Sub-block S22 computes distances between the reference property value and the current property values of the one or more search targets.

For example, the distances between the current property values Xᵢ of the one or more search targets and the reference property value Yᵢ may be calculated using the following formula:

distance(X,Y)=\sqrt{Σᵢ₌₁ⁿ(xᵢ−yᵢ)²}.

Sub-block S23 orders the one or more search targets of the data set according to the distances.

Using the embodiments of the present disclosure, for current search results of one or more search targets that are obtained in a search initiated by a user, current property values of the one or more search targets are separately obtained. Respective distances between the current property values of the one or more search targets and the reference property value are separately computed. Finally, the one or more search targets in the data set are arranged according to an ascending order of the respective distances to allow the user to obtain a search result of the ordered search targets. Under this circumstance, the user can obtain search result data that meets his/her individualized needs without requiring to submit a search condition, thus greatly simplifying operations of the user. The user no longer needs to change a search criterion in order to obtain his/her desired search result so that each website server does not need to repeatedly process requests of a client. Therefore, the embodiments of the present disclosure saves resources of the client and the server and effectively improves the search efficiency.

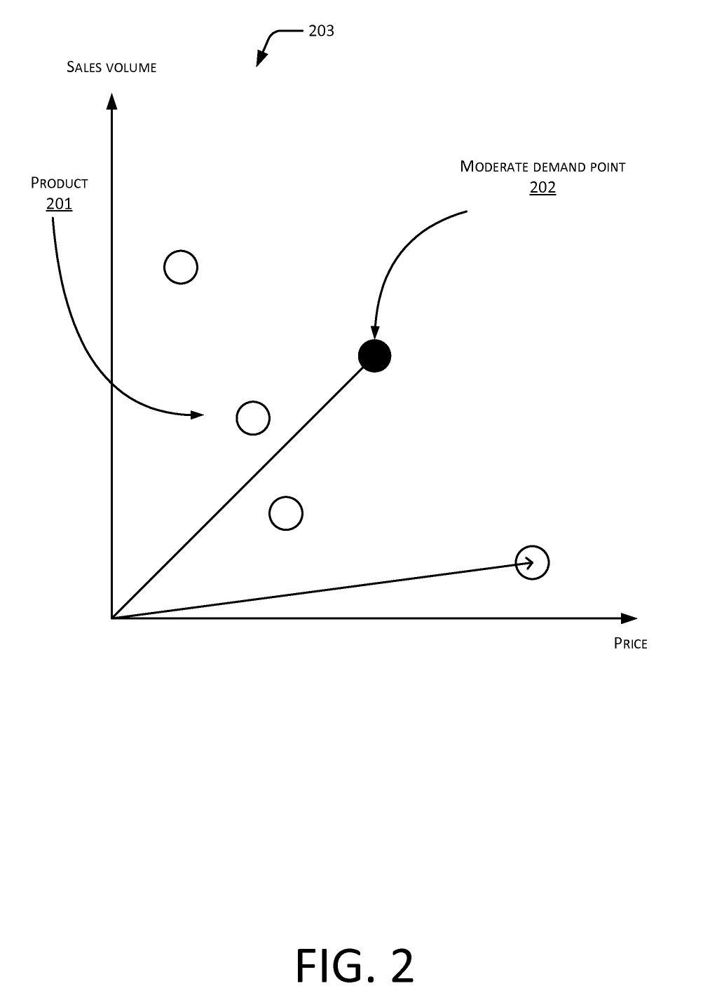

In order to facilitate intuitive understanding of one of ordinary skill in the art, FIG. 2 shows a schematic diagram illustrating an example of placing current property values of product data 201 and data of a moderate demand point 202 into a two-dimensional space 203 of price-sales volume (i.e., two-dimensions associated with the property values). After current property values of one or more product data in the two-dimensional space and a reference property value of the product data are obtained, an ordering is performed based on distances between the one or more product data points and the reference property value from the nearest to the farthest.

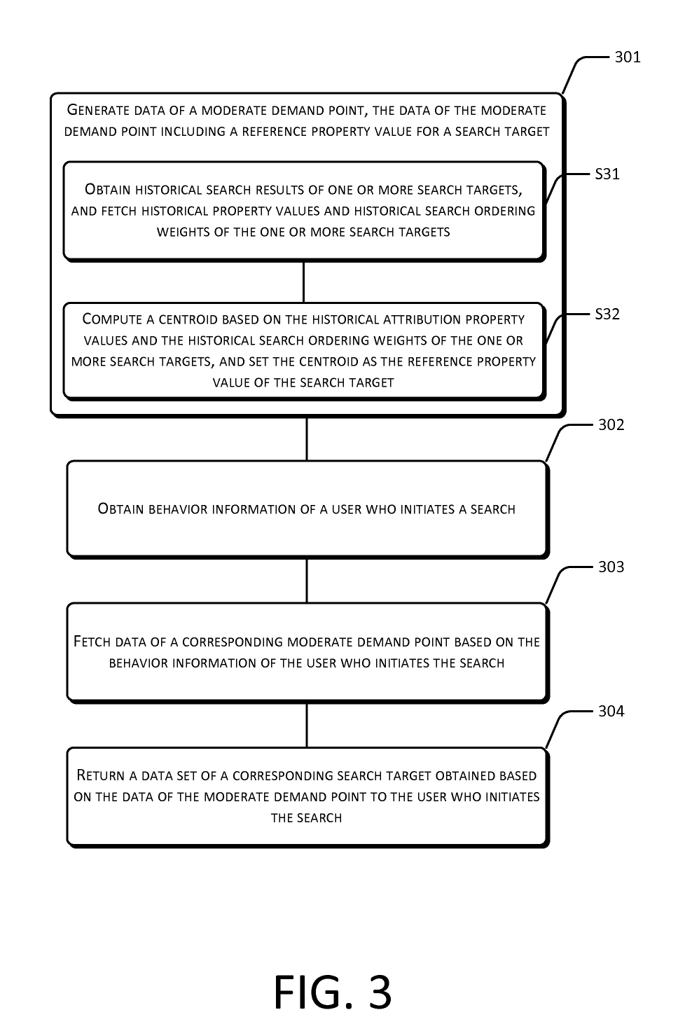

FIG. 3 shows a flowchart illustrating an example method of data searching, which includes:

Block 301 generates data of a moderate demand point, the data of the moderate demand point including a reference property value for a search target.

In some embodiments, block 301 may include the following sub-blocks:

Sub-block S31 obtains historical search results of one or more search targets, and fetches historical property values and historical search ordering weights of the one or more search targets.

Sub-block S32 computes a centroid based on the historical property values and the historical search ordering weights of the one or more search targets, and sets the centroid as the reference property value of the search target.

As an example used in the embodiments of the present disclosure, a centroid may be calculated using the following formula:

$$Y = \frac{{\sum }_{i = 1}^{k} {m}_{i} {X}_{i}}{{\sum }_{i = 1}^{k} {m}_{i}} ,$$

wherein k is the number of search targets, m is a historical search order weight of a search target, and Xᵢ is a historical property value of the search target.

In one embodiment, the historical search results of the one or more search targets may include historical search results of one or more search targets obtained for queries that are initialized by a plurality of users. In this case, the sub-block S32 may further include the following sub-steps:

1) separately computing respective centroids of s number of users using the following formula, wherein s is a positive integer greater than one:

$$Y = \frac{{\sum }_{i = 1}^{k} {m}_{i} {X}_{i}}{{\sum }_{i = 1}^{k} {m}_{i}} ,$$

wherein k is the number of search targets, m is a historical search order weight of a search target, Xᵢ is a historical property value of the search target;

2) obtaining the respective centroids of the s number of users as {Y₁, Y₂, . . . , Y₅};

3) obtaining a centroid as the reference property value of the search target from the respective centroids of the s number of users using the following formula:

$${Y}_{new} = \frac{{\sum }_{i = 1}^{s} {Y}_{i}}{s} ,$$

wherein Yᵢ is from Y₁ to Y₅.

In some embodiments, the plurality of users may be neighbor users. The neighbor users may include a set of users having a degree of similarity for user behavior greater than a first threshold value.

Block 302 obtains behavior information of a user who initiates a search.

In the embodiments of the present disclosure, a user who initiates a search includes not only a user who directly submits a query request, a user who conducts a search by submitting a keyword, but also a user to whom information is recommended as needed by system configuration. For example, immediately recommending information to a user who just logs in or visits a website, and this type of user is also considered as a user who initiates a search. In short, a user who triggers a search operation is considered as a user who initiates a search.

Block 303 fetches data of a corresponding moderate demand point based on the behavior information of the user who initiates the search.

In some embodiments, block 303 may include the following sub-blocks (not shown).

Sub-block S41 computes a degree of similarity between the behavior information of the user who initiates the search and behavior of a neighbor user set.

Sub-block S42 determines that the behavior information of the user who initiates the search belongs to the neighbor user set if greater than a first threshold value.

Sub-block S43 fetches a reference property value of a search target corresponding to the neighbor user set to which the user who initiates the search belongs, and taking the reference property value of the search target as data of a moderate demand point that matches the search initiated by the user.

The above method is only an example embodiment for accurately satisfying the needs of a user. In one embodiment, it is plausible for one of ordinary skill in the art to employ any method of fetching data of a moderate demand point based on behavior information of a user who initiates a search. For example, information of a search target may be obtained from a search keyword or a search criterion submitted by a user, and data of a moderate demand point corresponding to the search target may be obtained directly from a database based on the information of the search target. Specifically, one of ordinary skill in the art can store correspondence relationships between search targets and corresponding reference property values in a database. When information of a search target is obtained from search behavior information of a user (e.g., a keyword submitted or a search criterion inputted or triggered by a user, etc.), a reference property value of the search target can be directly extracted. The present disclosure has no limitation thereon.

Block 304 returns a data set of a corresponding search target obtained based on the data of the moderate demand point to the user who initiates the search.

Specifically, block 304 may include the following sub-blocks (not shown):

Sub-block S51 obtains a current search result of one or more search targets, and fetches current property values of the one or more search targets.

Sub-block S52 separately computes respective distances between the reference property value and the current property values of the one or more search targets.

Sub-block S53 orders the one or more search targets according to the respective distances.

Sub-block S54 returns a data set of the ordered search targets to the user.

In one embodiment, block 304 may further include:

Sub-block S55 deletes a specific search target from the data set of the search targets, the specific search target being a search target having a distance between the reference property value and the current property value thereof greater than a second threshold value.

In the embodiments of the present disclosure, the first threshold value and the second threshold value may be arbitrarily set by one of ordinary skill in the art based on actual condition, and the present has no limitation thereon.

In one embodiment, the behavior information of the user may be obtained from a log of user operations, a local historical record, or predetermined software, e.g., past commodity data search initiated by the user after adjustments of desired prices and sales volumes of commodities. It should be noted that, in the embodiments of the present disclosure, data of a moderate demand point is continually updated as behavior information of a user continually changes. Specifically, data of a moderate demand point that matches neighbor users better can be obtained based on more pieces of behavior information of the user, thus satisfying the actual needs of the user in a better manner.

In one embodiment, a user may locate data of a different moderate demand point and obtain a different ordering of search targets by adjusting requirements in different dimensions, e.g., reducing the requirement for price and increasing the requirement for sales volume. An interface for user adjustment may be an interactive tool in form of an interface set up in the front end, or a slider in the front end of a web page. The present disclosure has no limitation thereon.

In some embodiments, the data of the moderate demand point may be submitted to a corresponding search engine as a query criterion. The search engine obtains a corresponding search result (a data set of a search target) based on its own search mechanism, initiating an online search based on the data of the moderate demand point. This type of implementation needs to store the data of the moderate demand point in the server only, thus effectively saving the resources of the server.

Additionally or alternatively, the data set of the search target corresponding to the data of the moderate demand point may be stored in the server, and a relationship between the data set of the search target and the data of the moderate demand point may be recorded. This embodiment is suitable for a search engine in a relatively small scaled website. In this situation, as the number of accesses to the website is small and the amount of user behavior information in the website is relatively small, the data of the moderate demand point can be updated regularly, rather than being updated in real time. Each time when the data of the moderate demand point is updated, the data set of the search target corresponding to the data of the moderate demand point may be stored. When a user initiates a search, a data set of a corresponding search target can be returned after being directly extracted from the server based on data of a matched moderate demand point. The present embodiment can reduce resources exchanged during communications between a client and a server and can also allow the user to obtain feedback at a faster rate.

It should be noted that the example methods have been described as a sequence of combinations of actions for the sake of description. However, one of ordinary skill in the art should understand that the present disclosure is not construed to the described order of actions. Based on the present disclosure, certain blocks may be performed in other orders or in parallel. Moreover, one of ordinary skill in the art should also understand that the embodiments described in the disclosure are exemplary embodiments, and actions thereof may not be needed in the present disclosure.

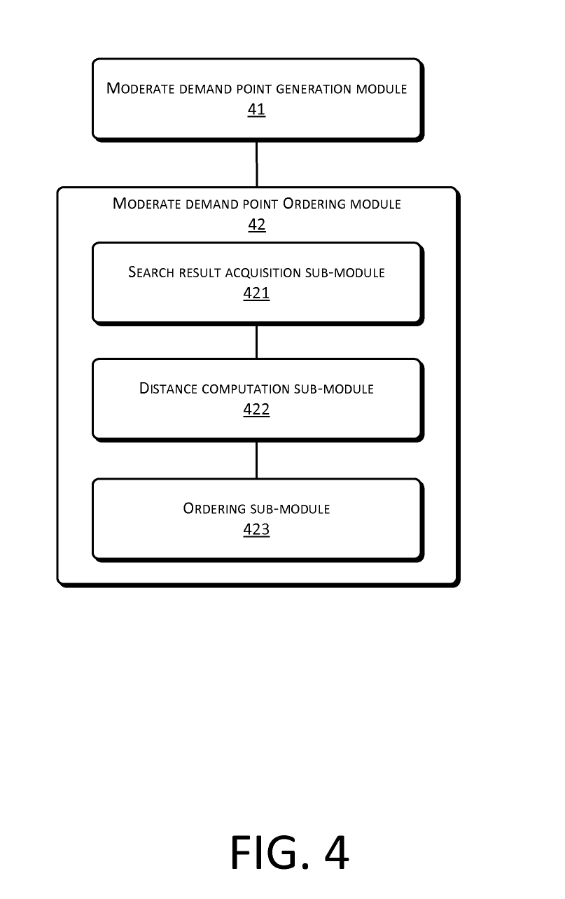

FIG. 4 shows a structural diagram illustrating an example apparatus of data searching, which may include the following modules:

a moderate demand point generation module 41, used for generating data of a moderate demand point, the data of the moderate demand point including a reference property value of a search target; and

a moderate demand point ordering module 42, used for ordering a corresponding data set associated with the search target based on the data of the moderate demand point, the moderate demand point ordering module including:

a search result acquisition sub-module 421, used for obtaining the data set that is associated with the search target, and obtaining current property values of one or more search targets from the data set;

a distance computation sub-module 422, used for computing distances between the current property values of one or more search targets and the reference property value; and

an ordering sub-module 423, used for ordering the one or more search targets of the data set based on the distances.

In some embodiments, the moderate demand point generation module 41 may include:

a historical search result analysis sub-module used for obtaining historical search results of the one or more search targets and extracting historical property values and historical search order weights of the one or more search targets; and

a moderate demand point computation sub-module used for computing a centroid based on the historical property values and the historical search order weights of the one or more search targets, and setting the centroid as the reference property value of the search target.

As an example employed in the embodiments of the present disclosure, the centroid may be computed using the following formula:

$$Y = \frac{{\sum }_{i = 1}^{k} {m}_{i} {X}_{i}}{{\sum }_{i = 1}^{k} {m}_{i}} ,$$

wherein k is the number of search targets, m is a historical search order weight of a search target, and Xᵢ is a historical property value of the search target.

In some embodiments, the historical search results of the one or more targets include historical search results of the one or more search targets obtained for queries that are initialized by a plurality of users. In this case, the moderate demand point computation sub-module further includes:

a single-user centroid computation unit used for separately computing respective centroids of s number of users using the following formula, where s is a positive integer greater than one:

$$Y = \frac{{\sum }_{i = 1}^{k} {m}_{i} {X}_{i}}{{\sum }_{i = 1}^{k} {m}_{i}} ,$$

wherein k is the number of search targets, m is a historical search order weight of a search target, Xᵢ is a historical property value of the search target;

a centroid organization unit used for obtaining the respective centroids of the s number of users as {Y₁, Y₂, . . . , Y₅};

a multiple-user centroid computation unit used for obtaining a centroid as the reference property value of the search target from the respective centroids of the s number of users using the following formula:

$${Y}_{new} = \frac{{\sum }_{i = 1}^{s} {Y}_{i}}{s} ,$$

wherein Yᵢ is from Y₁ to Y₅.

In one embodiment, the plurality of users may be neighbor users. The neighbor users may include a set of users having a degree of similarity for user behavior greater than a first threshold value.

In some embodiments, the reference property value, the historical property values, and the current property values of the search target may be represented as a n-dimensional vector of X={x₁, x₂, . . . , xₙ}, wherein n is a positive integer.

In one embodiment, the moderate demand point ordering module 42 may further include:

a filtering sub-module used for deleting a specific search target from the data set of the search target, the specific search target being a search target having a distance between the reference property value and the current property value thereof greater than a second threshold value.

Since the example apparatus basically corresponds to the example method as shown in FIG. 1, the details that are not covered in the present embodiment can be found in related description of the foregoing embodiments, and will not be redundantly described herein.

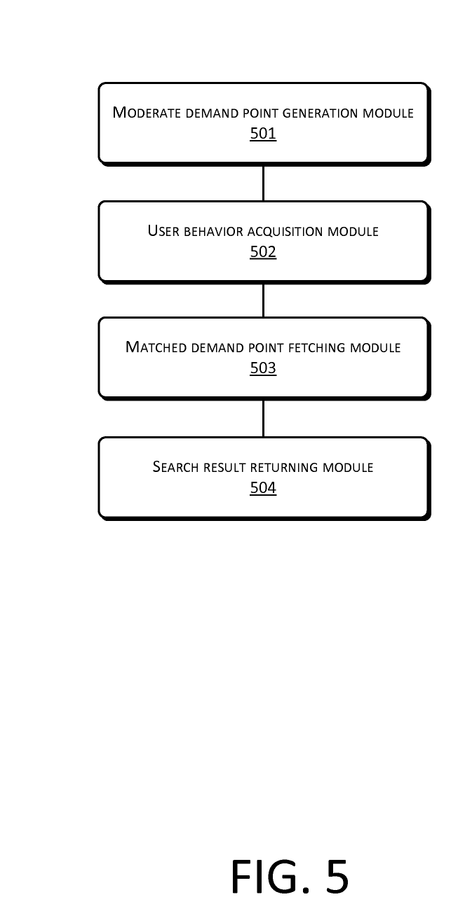

FIG. 5 shows a structural diagram illustrating an example apparatus of data searching, which may include the following modules:

a moderate demand point generation module 501, used for generating data of a moderate demand point, the data of the moderate demand point including a reference property value of a search target;

a behavior information acquisition module 502, used for obtaining behavior information of a user who initiates a search;

a matched demand point fetching module 503, used for fetching data of a matched moderate demand point based on the behavior information of the user who initiates the search; and

a search result returning module 504, used for returning, to the user who initiates the search, a data set of a corresponding search target that is obtained based on the data of the matched moderate demand point, wherein one or more search targets included in the data set of the search target include current property values, and the one or more search targets are ordered according to distances between the current property values and the reference property value of the search target.

In some embodiments, the moderate demand point generation module may include the following sub-modules (not shown):

a historical search result analysis sub-module used for obtaining historical search results of the one or more search targets and extracting historical property values and historical search ordering weights of the one or more search targets; and

a moderate demand point computation sub-module used for calculating a centroid according to the historical property values and the historical search ordering weights of the one or more search targets and setting the centroid as the reference property value of the search target.

As an example employed in the embodiments of the present disclosure, the centroid may be computed using the following formula:

$$Y = \frac{{\sum }_{i = 1}^{k} {m}_{i} {X}_{i}}{{\sum }_{i = 1}^{k} {m}_{i}} ,$$

wherein k is the number of search targets, m is a historical search order weight of a search target, and Xᵢ is a historical property value of the search target.

In some embodiments, the historical search results of the one or more targets include historical search results of the one or more search targets obtained for queries that are initialized by a plurality of users. In this case, the moderate demand point computation sub-module may further include the following units:

a single-user centroid computation unit used for separately computing respective centroids of s number of users using the following formula, wherein s is a positive integer greater than one:

$$Y = \frac{{\sum }_{i = 1}^{k} {m}_{i} {X}_{i}}{{\sum }_{i = 1}^{k} {m}_{i}} ,$$

wherein k is the number of search targets, m is a historical search order weight of a search target, Xᵢ is a historical property value of the search target;

a centroid organization unit used for obtaining the respective centroids of the s number of users as {Y₁, Y₂, . . . , Y₅};

a multiple-user centroid computation unit used for obtaining a centroid as the reference property value of the search target from the respective centroids of the s number of users using the following formula:

$${Y}_{new} = \frac{{\sum }_{i = 1}^{s} {Y}_{i}}{s} ,$$

wherein Yᵢ is from Y₁ to Y₅.

In some embodiments, the plurality of users correspond to neighbor users. The neighbor users include a set of users having a degree of similarity for user behavior greater than a first threshold value.

In some embodiments, the matched demand point fetching module may include the following sub-modules:

a behavior similarity degree computation sub-module used for calculating a degree of similarity between the behavior information of the user who initiates the search and behavior of a neighbor user set;

a determination sub-module used for determining that the behavior information of the user who initiates the search belongs to the neighbor user set when the degree of similarity is greater than a first threshold value; and

a matched point fetching sub-module used for fetching a reference property value of a search target corresponding to the neighbor user set to which the user who initiates the search belongs, and setting the reference property value of the search target as the data of the moderate demand point corresponding to the user who initiates the search.

In one embodiment, the search result returning module may include the following sub-modules:

a search result acquisition sub-module used for obtaining current search results of the one or more search targets, and fetching current property values of the one or more search targets;

a distance computation sub-module used for separately computing respective distances between the current property values of the one or more search targets and the reference property value;

an ordering sub-module used for ordering the one or more search targets according to the respective distances; and

a feedback sub-module used for returning the ordered data set of the search target set to the user.

In some embodiments, the search result returning module may further include the following sub-modules (not shown):

a filtering sub-module used for deleting a specific search target from the data set of the search target, the specific search target being a search target having a distance between the reference property value and the current property value thereof greater than a second threshold value.

Since the example apparatus basically corresponds to the example method as shown in FIG. 3, the details that are not covered in the present embodiment can be found in related description of the foregoing embodiments, and will not be redundantly described herein.

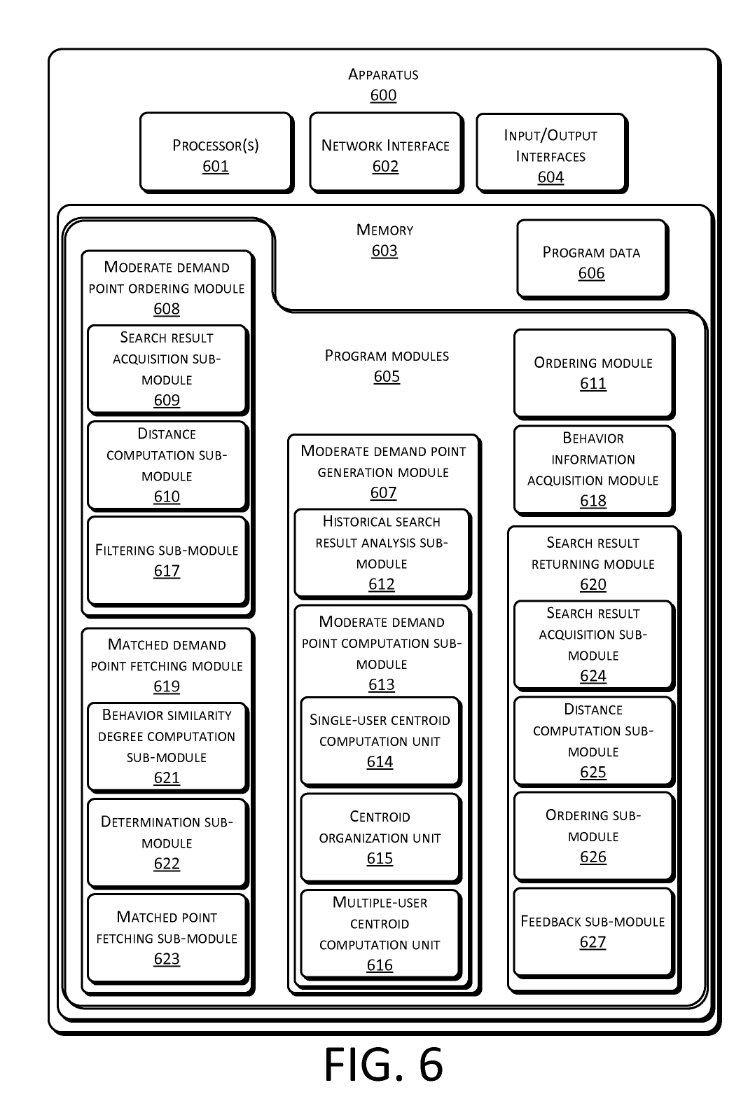

One of ordinary skill in the art should understand that the embodiments of the present disclosure may be implemented as methods, systems, or products of computer software. Therefore, the present disclosure may be implemented in forms of hardware, software, or a combination of hardware and software. Further, the present disclosure may be implemented in the form of products of computer software executable on one or more computer readable storage media (including but not limited to disk storage device, CD-ROM, optical storage device, etc.) that include computer readable program instructions. For example, FIG. 6 illustrates an example apparatus 600, such as the apparatus as described above, in more detail. In one embodiment, the apparatus 600 can include, but is not limited to, one or more processors 601, a network interface 602, memory 603, and an input/output interface 604.

The memory 603 may include computer-readable media in the form of volatile memory, such as random-access memory (RAM) and/or non-volatile memory, such as read only memory (ROM) or flash RAM. The memory 603 is an example of computer-readable media.

Computer-readable media includes volatile and non-volatile, removable and non-removable media implemented in any method or technology for storage of information such as computer readable instructions, data structures, program modules, or other data. Examples of computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. As defined herein, computer-readable media does not include transitory media such as modulated data signals and carrier waves.

The memory 603 may include program modules 605 and program data 606. In one embodiment, the program modules 605 may include a moderate demand point generation module 607, a moderate demand point ordering module 608, a search result acquisition sub-module 609, a distance computation sub-module 610, an ordering sub-module 611, a historical search result analysis sub-module 612, a moderate demand point computation sub-module 613, a single-user centroid computation unit 614, a centroid organization unit 615, a multiple-user centroid computation unit 616, a filtering sub-module 617, a behavior information acquisition module 618, a matched demand point fetching module 619, a search result returning module 620, a behavior similarity degree computation sub-module 621, a determination sub-module 622, a matched point fetching sub-module 623, a search result acquisition sub-module 624, a distance computation sub-module 625, an ordering sub-module 626 and a feedback sub-module 627. Details about these program modules, sub-modules and units may be found in the foregoing embodiments described above.

The present disclosure is described in accordance with flowcharts and/or block diagrams of the exemplary methods, apparatuses (systems) and computer program products. It should be understood that each process and/or block and combinations of the processes and/or blocks of the flowcharts and/or the block diagrams may be implemented in the form of computer program instructions. Such computer program instructions may be provided to a general purpose computer, a special purpose computer, an embedded processor or another processing apparatus having a programmable data processing device to generate a machine, so that an apparatus having the functions indicated in one or more blocks described in one or more processes of the flowcharts and/or one or more blocks of the block diagrams may be implemented by executing the instructions by the computer or the other processing apparatus having programmable data processing device.

Such computer program instructions may also be stored in a computer readable memory device which may cause a computer or another programmable data processing apparatus to function in a specific manner, so that a manufacture including an instruction apparatus may be built based on the instructions stored in the computer readable memory device. That instruction device implements functions indicated by one or more processes of the flowcharts and/or one or more blocks of the block diagrams.

The computer program instructions may also be loaded into a computer or another programmable data processing apparatus, so that a series of operations may be executed by the computer or the other data processing apparatus to generate computer implemented processing. Therefore, the instructions executed by the computer or the other programmable apparatus may be used to implement one or more processes of the flowcharts and/or one or more blocks of the block diagrams.

Although exemplary embodiments of the present disclosure are provided, one of ordinary skill in the art may change and modify theses exemplary embodiments upon understanding the underlying inventive concepts thereof. Therefore, claims attached herein are intended to cover the exemplary embodiments and all the changes and modifications that fall into the scope of the present disclosure.

Finally, it should be pointed out that terms such as “include”, “have” or any other variants cover non-exclusively “comprising”. Therefore, processes, methods, articles or devices which individually include a collection of features may not only be including those features, but may also include other features that are not listed, or any inherent features of these processes, methods, articles or devices. Without any further limitation, a feature defined within the phrase “include a . . . ” does not exclude the possibility that process, method, article or device that recites the feature may have other equivalent features.

A method and an apparatus of ordering search data and a method and an apparatus of data searching have been described in the present disclosure in detail above. Exemplary embodiments are employed to illustrate the concept and implementation of the present invention in this disclosure. The exemplary embodiments are only used for better understanding of the method and the core concepts of the present disclosure. Based on the concepts in this disclosure, one of ordinary skill in the art may modify the exemplary embodiments and application fields. All in all, contents in the present disclosure should not be construed as limitations to the present disclosure.

What is claimed is:

1. A method of ordering search data, comprising:
generating data of a moderate demand point, the data of the moderate demand point including a reference property value of a search target; and
ordering a corresponding data set associated with the search target based on the data of the moderate demand point, the ordering including:
obtaining the data set of the search target, and obtaining current property values of one or more search targets from the data set;
computing distances between the current property values of one or more search targets and the reference property value; and
ordering the one or more search targets of the data set based on the distances.

2. The method as recited in claim 1, wherein generating the data of the moderate demand point comprises:
obtaining historical search results of the one or more search targets and extracting historical property values and historical search order weights of the one or more search targets; and
computing a centroid based on the historical property values and the historical search order weights of the one or more search targets, and setting the centroid as the reference property value of the search target.

3. The method as recited in claim 1, wherein the centroid value is computed using the following formula:
$$Y = \frac{{\sum }_{i = 1}^{k} {m}_{i} {X}_{i}}{{\sum }_{i = 1}^{k} {m}_{i}} ,$$
wherein k is a number of search targets, m is a historical search order weight of a respective search target, and Xᵢ is a historical property value of the respective search target.

4. The method as recited in claim 2, wherein the historical search results of the one or more search targets comprise historical search results of the one or more search targets obtained for queries that are initialized by a plurality of users, and
computing the centroid based on the historical property values and the historical search order weights of the one or more search targets to set the centroid as the reference property value of the search target, comprises:
separately computing respective centroids of s number of users, wherein s is a positive integer greater than one;
obtaining a centroid as the reference property value of the search target from the respective centroids of the s number of users.

5. The method as recited in claim 4, wherein the plurality of users are neighbor users, the neighbor users comprising a set of users having a degree of similarity for user behavior that greater than a first threshold value.

6. The method as recited in claim 2, wherein the reference property value, the historical property values, and the current property values of the search target are represented as a n-dimensional vector, wherein n is a positive integer.

7. The method as recited in claim 1, wherein ordering the corresponding data set associated with the search target based on the data of the moderate demand point further comprises:
deleting a specific search target from the data set of the search target, the specific search target being a search target having a distance between the reference property value and the current property value thereof greater than a second threshold value.

8. A method of searching data, comprising:
generating data of a moderate demand point, the data of the moderate demand point including a reference property value of a search target;
obtaining behavior information of a user who initiates a search;
fetching data of a matched moderate demand point based on the behavior information of the user who initiates the search; and
returning, to the user who initiates the search, a data set of a corresponding search target that is obtained based on the data of the matched moderate demand point;
wherein one or more search targets included in the data set of the search target include current property values, and the one or more search targets are ordered according to distances between the current property values and the reference property value of the search target.

9. The method as recited in claim 8, wherein generating the data of the moderate demand point comprises:
obtaining historical search results of the one or more search targets and extracting historical property values and historical search ordering weights of the one or more search targets; and
calculating a centroid according to the historical property values and the historical search ordering weights of the one or more search targets and setting the centroid as the reference property value of the search target.

10. The method as recited in claim 9, wherein the centroid is calculated using the following formula:
$$Y = \frac{{\sum }_{i = 1}^{k} {m}_{i} {X}_{i}}{{\sum }_{i = 1}^{k} {m}_{i}} ,$$
wherein k is a number of search targets, m is a historical search order weight of a respective search target, and Xᵢ is a historical property value of the respective search target.

11. The method as recited in claim 9, wherein the historical search results of the one or more targets include historical search results of the one or more search targets obtained for queries that are initialized by a plurality of users, and
computing the centroid based on the historical property values and the historical search order weights of the one or more search targets to set the centroid as the reference property value of the search target, comprises:
separately computing respective centroids of s number of users using the following formula, where s is a positive integer greater than one;
obtaining a centroid as the reference property value of the search target from the respective centroids of the s number of users.

12. The method as recited in claim 11, wherein the plurality of users are neighbor users, the neighbor users comprising a set of users having a degree of similarity for user behavior greater than a first threshold value.

13. The method as recited in claim 9, wherein the reference property value, the historical property values, and the current property values of the search target are represented as a n-dimensional vector, wherein n is a positive integer.

14. The method as recited in claim 12, wherein fetching the data of the matched moderate demand point based on the behavior information of the user who initiates the search includes:
calculating a degree of similarity between the behavior information of the user who initiates the search and behavior of a neighbor user set;
determining that the behavior information of the user who initiates the search belongs to the neighbor user set when the degree of similarity is greater than a first threshold value; and
fetching a reference property value of a search target corresponding to the neighbor user set to which the user who initiates the search belongs, and setting the reference property value of the search target as the data of the moderate demand point corresponding to the user who initiates the search.

15. The method as recited in claim 8, wherein returning, to the user who initiates the search, the data set of the corresponding search target that is obtained based on the data of the matched moderate demand point, comprises:
obtaining current search results of the one or more search targets, and fetching current property values of the one or more search targets;
separately computing respective distances between the current property values of the one or more search targets and the reference property value;
ordering the one or more search targets according to the respective distances; and
returning the ordered data set of the search target set to the user.

16. The method as recited in claim 15, wherein returning, to the user who initiates the search, the data set of the corresponding search target that is obtained based on the data of the matched moderate demand point further includes:
deleting a specific search target from the data set of the search target, the specific search target being a search target having a distance between the reference property value and the current property value thereof greater than a second threshold value.

17. An apparatus of ordering search data, comprising:
a moderate demand point generation module used for generating data of a moderate demand point, the data of the moderate demand point including a reference property value of a search target; and
a moderate demand point ordering module used for ordering a corresponding data set associated with the search target based on the data of the moderate demand point, the moderate demand point ordering module including:
a search result acquisition sub-module used for obtaining the data set that is associated with the search target, and obtaining current property values of one or more search targets from the data set;
a distance computation sub-module used for computing distances between the current property values of one or more search targets and the reference property value; and
an ordering sub-module used for ordering the one or more search targets of the data set based on the distances.

18. The apparatus as recited in claim 17, wherein the moderate demand point generation module comprises:
a historical search result analysis sub-module used for obtaining historical search results of the one or more search targets and extracting historical property values and historical search order weights of the one or more search targets; and
a moderate demand point computation sub-module used for computing a centroid based on the historical property values and the historical search order weights of the one or more search targets, and setting the centroid as the reference property value of the search target.

19. The apparatus as recited in claim 18, wherein the historical search results of the one or more targets include historical search results of the one or more search targets obtained for queries that are initialized by a plurality of users, and
the moderate demand point computation sub-module further comprises:
a single-user centroid computation unit used for separately computing respective centroids of s number of users using the following formula, where s is a positive integer greater than one:
$$Y = \frac{{\sum }_{i = 1}^{k} {m}_{i} {X}_{i}}{{\sum }_{i = 1}^{k} {m}_{i}} ,$$
wherein k is a number of search targets, m is a historical search order weight of a respective search target, Xᵢ is a historical property value of the respective search target;
a centroid organization unit used for obtaining the respective centroids of the s number of users as {Y₁, Y₂, . . . , Y₅};
a multiple-user centroid computation unit used for obtaining a centroid as the reference property value of the search target from the respective centroids of the s number of users using the following formula:
$${Y}_{new} = \frac{{\sum }_{i = 1}^{s} {Y}_{i}}{s} ,$$
wherein Yᵢ is from Y₁ to Y₅.

20. The apparatus as recited in claim 17, wherein the moderate demand point ordering module further comprises:
a filtering sub-module used for deleting a specific search target from the data set of the search target, the specific search target being a search target having a distance between the reference property value and the current property value thereof greater than a second threshold value.
